(19) United States
(12) Patent Application Publication
(10) Pub. No.: US 2021/0366644 A1
(43) Pub. Date: Nov. 25, 2021

(54) ARRANGEMENT AND TRANSFORMER COMPRISING THE ARRANGEMENT

(71) Applicant: ScandiNova Systems AB, Uppsala (SE)

(72) Inventors: Emil VIDLIN, Uppsala (SE); Per NILSSON, Uppsala (SE)

(73) Assignee: ScandiNova Systems AB, Uppsala (SE)

(21) Appl. No.: 16/753,410

(22) PCT Filed: Oct. 3, 2018
(86) PCT No.: PCT/EP2018/076918

§ 371 Date: Apr. 3, 2020

(30) Foreign Application Priority Data
Oct. 4, 2017 (EP) 17194682.5

(51) Int. Cl. H01F 27/08; H01F 27/02; H01F 27/28; H01F 27/24; H01F 3/14

(52) U.S. Cl. CPC H01F 27/085; H01F 27/025; H01F 3/14; H01F 27/24; H01F 27/2876

(57) ABSTRACT

An arrangement (10, 20, 30) id disclosed, comprising a magnetic element (10) and at least a first winding (10) and a second winding (20), wherein each of the first winding (20) and the second winding (30) is wound in a plurality of turns (41, 42, 43, 44, 51, 52, 53, 54) around at least a portion of the magnetic element (10), and wherein at least a part or portion of the plurality of turns (51, 52, 53, 54) of the second winding (30) wound around the at least a portion of the magnetic element is arranged in spaced relation to at least a part or portion of the plurality of turns (41, 42, 43, 44) of the first winding (20) wound around the at least a portion of the magnetic element (10), thereby defining at least one gap (61, 62) between the at least a part or portion of the plurality of turns (51, 52, 53, 54) of the second winding (30) and the at least a part or portion of the plurality of turns (41, 42, 43) of the first winding (20). At least the magnetic element (10) and the first winding (20) and the second winding (30) define an assembly of the arrangement (10, 20, 30), and wherein at least a part or portion of the assembly is arranged so as to be embedded in a thermally conductive material (70) and such that at the same time a flow of air in the at least one gap (61, 62) is permitted.

### TECHNICAL FIELD

The present invention generally relates to the field of electrical systems. Specifically, the present invention relates to an arrangement, e.g., a transformer arrangement, which may be employed for example in a power supply used for charging an electrical energy storage module (e.g., comprising a capacitor, or a capacitor bank) which when discharged may generate an electrical pulse.

### BACKGROUND

Electrical pulses may be employed in a variety of applications, such as, for example, radar systems, particle accelerators, sterilization equipment, high-energy lasers, microwave systems, or medical devices. In such and other applications it may be desired or required to deliver one or more electrical pulses to a load. Systems or circuits which are employed for generating electrical pulses may be referred to as power modulators.

A system or device for generating electrical pulses, e.g., a power modulator, may comprise a power supply connected to an electrical energy storage module for supplying power to the electrical energy storage module. The electrical energy storage module may for example may comprise a capacitor or several capacitors for example arranged so as to form a capacitor bank. The electrical energy storage module may be selectively charged and discharged, partially or (substantially) completely. By the power supply being configured to supply power to the electrical energy storage module, the electrical energy storage module may be charged by the power supplied thereto from the power supply. After the electrical energy storage module has been charged partially or completely, the electrical energy storage module may be discharged partially or completely, for example for generating at least one electrical pulse, which may be delivered to a load. After the electrical energy storage module has been partially or fully discharged, it may then be partially or completely charged again by power supplied thereto from the power supply, such that the electrical energy storage module is repeatedly (e.g., cyclically or periodically) charged and discharged, whereby a series of electrical pulses may be generated. A pulse transformer may be employed in such a system for generating electrical pulses, which pulse transformer for example may be arranged in the power supply. In order to obtain required or desired energy of the electrical pulses, relatively high currents and/or voltages may be needed, which may pose a challenge for the thermal management in the system or device for generating electrical pulses, such as, for example, in pulse transformer included in the system or device.

### SUMMARY

In view of the above, a concern of the present invention is to provide an arrangement, e.g., a transformer arrangement, which may be employed for example in a power supply used for charging an electrical energy storage module (e.g., comprising a capacitor, or a capacitor bank) which when discharged may generate an electrical pulse, which arrangement may facilitate for a relatively efficient thermal management thereof.

To address at least one of this concern and other concerns, an arrangement and a method in accordance with the independent claims are provided. Preferred embodiments are defined by the dependent claims.

According to a first aspect there is provided an arrangement which for example be comprised in a transformer. The arrangement comprises a magnetic element, and at least a first winding and a second winding, wherein each of the first winding and the second winding is wound in a plurality of turns around at least a portion of the magnetic element so that the first winding is arranged in relation to the second winding, or vice versa, such that the plurality of turns of the second winding are arranged around the plurality of turns of the first winding. At least a part or portion of the plurality of turns of the second winding wound around the at least a portion of the magnetic element is arranged in spaced relation to at least a part or portion of the plurality of turns of the first winding wound around the at least a portion of the magnetic element, thereby defining at least one gap between the at least a part or portion of the plurality of turns of the second winding and the at least a part or portion of the plurality of turns of the first winding. At least the magnetic element and the first winding and the second winding define an assembly of the arrangement. A part or portion of the assembly is arranged so as to be embedded in a thermally conductive material such that at least a part or portion of the magnetic element, the first winding, and the second winding, respectively, is embedded in the thermally conductive material, and such that at the same time a flow of air (and/or another or other types of gas or fluid in the surroundings of the arrangement) in the at least one gap (e.g., through the at least one gap) is permitted.

Accordingly, at least a part or portion of each of the magnetic element, the first winding, and the second winding may be embedded in the same thermally conductive material. By embedding of at least a part or portion of the assembly in a thermally conductive material, transfer of heat, which may have been generated by the arrangement when in use (e.g., when current is flowing in the first and second windings), away from the arrangement may be facilitated. At the same time, at least a portion of the plurality of turns of the second winding and/or the plurality of turns of the first winding, and possibly a portion of the magnetic element, may be cooled by means of convection as air flows in the at least one gap. For example, the at least one gap may be in fluid communication with air, e.g., ambient air. Thereby, the arrangement may facilitate for a relatively efficient thermal management thereof, so as to provide for a high reliability and prevention of premature failure. Further, by increasing the extent to which the at least a part or portion of the assembly is embedded in the thermally conductive material, and/or enlarging the at least one gap (which may allow for an increased flow of air in the at least one gap), transfer of heat away from the arrangement may be increased. Thus, thermal management in the arrangement may be adapted so comply with different requirements, possibly depending on the particular application in which the arrangement is to be employed.

By the at least a part or portion of the assembly being arranged so as to be embedded in a thermally conductive material, it is meant that the at least a part or portion of the assembly may be fixed or enclosed relatively firmly in the thermally conductive material surrounding the at least a part or portion of the assembly. Furthermore, by the at least a part or portion of the assembly being embedded in the thermally conductive material while permitting a flow of air in the at least one gap (e.g., through the at least one gap), it is meant that the at least a part or portion of the assembly has been embedded in the thermally conductive material such that the at least one gap is not completely filled with the thermally conductive material, or even such that the at least one gap is not filled with any thermally conductive material at all, such that a passage for airflow is formed within the at least one gap so that at least at least a portion of the plurality of turns of the second winding and/or the plurality of turns of the first winding, and possibly a portion of the magnetic element, can be cooled by means of convection as air (and/or another or other types of gas or fluid in the surroundings of the arrangement) flows in the passage. The convection may be natural convection or forced convection. Forced convection may be caused for example by means of a fan or a pump.

The at least a part or portion of the assembly being arranged so as to be embedded in a thermally conductive material may according to one or more embodiments of the present invention be understood as that a part or portion of each of the magnetic element, the first winding and the second winding is embedded in the thermally conductive material. However, this is according to an example, and is not required. For example, according to one or more other embodiments of the present invention, the at least a part or portion of the assembly being arranged so as to be embedded in a thermally conductive material may be understood as that at least a part or portion of the magnetic element is embedded in the thermally conductive material, and that at least a part or portion of one of the first winding and the second winding is embedded in the thermally conductive material (i.e. so that the winding may or may not be embedded in its entirety), while only a part or portion of the other one of the first winding and the second winding is embedded in the thermally conductive material (i.e. so that the winding is not embedded in its entirety). The first winding and/or the second winding may hence not be embedded in its/their entirety in the thermally conductive material.

The first winding and the second winding may for example constitute parts or portions of a single winding, wherein the first winding and the second winding may be connected to each other. According to another example, the first winding and the second winding may constitute separate windings, which are not connected to each other.

In the context of the present application, by the term thermally conductive material it is meant a material distinct from air surrounding the arrangement (i.e., ‘ambient’ air) (and/or another or other types of gas or fluid in the surroundings of the arrangement). The thermally conductive material may be chosen so as to have a thermal conductivity within a certain thermal conductivity range, such as, for example, more than 0.5 W/(m·K). The thermally conductive material may for example comprise a thermally conductive resin, which may have been arranged such that the at least a portion of the magnetic element and portions of the first winding and the second winding, respectively, are arranged therein, after which the thermally conductive resin may have been cured, making the cured thermally conductive resin rigid.

Each of the first winding and the second winding may be wound in a plurality of turns around at least a portion of the magnetic element so that the first winding is arranged in relation to the second winding, or vice versa, such that the plurality of turns of the second winding are arranged around the plurality of turns of the first winding. The plurality of turns of the second winding may be referred to as an outer winding, and the plurality of turns of the first winding may be referred to as an inner winding. For example, the plurality of turns of the first winding and the plurality of turns of the second winding may form layers, e.g., two different layers, which layers may be running or extending along a longitudinal axis of the at least a portion of the magnetic element (e.g., the layers running in ‘parallel’ on the outside of the at least a portion of the magnetic element), and with the layer formed by the plurality of turns of the second winding being arranged over the layer formed by the plurality of turns of the first winding in a direction away from the at least a portion of the magnetic element. The at least one gap may be arranged between the layer formed by the plurality of turns of the second winding and the layer formed by the plurality of turns of the first winding, or, in general, between two adjacent layers. Each or any of the at least one gap may for example be constituted by a void, or space, between the plurality of turns of the second winding and the plurality of turns of the first winding, which may be oriented or extending (substantially) parallel to, or (substantially) transversely with respect to, the longitudinal axis of the at least a portion of the magnetic element. Possibly, in a configuration wherein the first winding is arranged inside the second winding, the first winding could be completely, or substantially completely, embedded in the thermally conductive material, while only a part or portion of the second winding may be embedded in the thermally conductive material. The magnetic element could in such a case be completely, or substantially completely, embedded in the thermally conductive material.

It is however to be understood that other configurations of the first winding and the second winding are possible. For example, each of the first winding and the second winding could for example be wound in a plurality of turns around at least a portion of the magnetic element such that the first winding and the second winding are arranged in relation to each other so that the plurality of turns of the first winding and the plurality of turns of the second winding are interleaved, thereby forming an interleaved structure of alternatingly turns of the first winding and turns of the second winding, wherein the interleaved structure may be arranged such that there is a gap between at least some adjacent turns in the interleaved structure. For example, there may in the interleaved structure be a gap between a turn of the first winding and a turn of the second winding that is adjacent to the turn of the first winding.

The part or portion of the plurality of turns of the first winding and the part or portion of the plurality of turns of the second winding defining the at least one gap may not be embedded in the thermally conductive material. For example, at least the parts or portions of the plurality of turns of the first winding and the second winding, respectively, which are delimiting, or bordering, a space formed by the at least one gap may not be embedded in the thermally conductive material. This may facilitate or allow for ensuring that a relatively high flow of air in the at least one gap may take place, thereby providing for a relatively high efficiency in cooling of at least a portion of the plurality of turns of the second winding and/or the plurality of turns of the first winding, and possibly a portion of the magnetic element, by means of convection as air flows in the at least one gap.

The at least one gap may extend between at least two ends thereof.

The at least a part or portion of the assembly may be arranged so as to be embedded in a thermally conductive material in such a way that at least two of the ends of the at least one gap open into the surroundings of the arrangement, and such that air may flow from one of the ends to another end. At least two of the ends of the at least one gap may for example open into the ambient air, thereby permitting a flow of air through the at least one gap from one end to another end thereof. This may facilitate or allow for ensuring that a flow of air which passes through the at least one gap may take place, which may possibly allow for achieving a relatively high efficiency in cooling of at least a portion of the plurality of turns of the second winding and/or the plurality of turns of the first winding, and possibly a portion of the magnetic element, by means of convection as air flows in the at least one gap.

It is not required for the at least one gap to extend between at least two ends thereof. For example, the at least one gap might have a single open end, which still would permit a flow of air within the at least one gap, with the air entering and exiting the at least one gap via the same open end.

Each of the first winding and the second winding may be wound in a plurality of turns around at least a portion of the magnetic element such that the at least one gap between the at least a part or portion of the plurality of turns of the second winding and the at least a part or portion of the plurality of turns of the first winding is running or extending along, or parallel with, a longitudinal axis of the at least a portion of the magnetic element.

The magnetic element may for example comprise or be constituted by at least one magnetic core.

The at least one magnetic core may have at least one leg. The at least a portion of the magnetic element around which the first winding and the second winding are wound may be located in a single leg of the at least one magnetic core.

The at least one magnetic core may have a plurality of legs (i.e. at least two legs). The at least a portion of the magnetic element around which the first winding and the second winding are wound may be located in several legs of the at least one magnetic core.

The magnetic core may comprise a single element. The magnetic core may for example comprise a base portion and two or more legs extending from the base portion. The magnetic core may for example comprise a so called “E” core, having three legs, or a so called “U” core, having two legs. However, other types of magnetic cores are possible. According to other examples, the magnetic core could for example comprise a toroidal core, or a ring-shaped core. The magnetic core may possibly be a split core, i.e. comprising two or more elements, and may for example comprise or be constituted by a pair of E cores.

The magnetic core may in principle comprise any magnetic material. The magnetic core may for example comprise one or more ferrite ceramics (e.g., a ‘ferrite core’) or the like, which material may be particularly suitable for high-frequency applications.

According to one or more embodiments of the present invention, less than half of the assembly may be embedded in the thermally conductive material. For example, less than a fourth, or a fifth, of the assembly may be embedded in the thermally conductive material. According to another example, less than a sixth or even less of the assembly may be embedded in the thermally conductive material. In general, the less of the assembly that is embedded in the thermally conductive material, the smaller the manufacturing costs for the arrangement may become.

The arrangement may comprise at least one spacer which may be arranged within the at least one gap for maintaining the spaced relation of the at least a part or portion of the plurality of turns of the second winding wound around the at least a portion of the magnetic element to the at least a part or portion of the plurality of turns of the first winding wound around the at least a portion of the magnetic element while permitting a flow of air within the at least one gap. By arranging of such a spacer within the at least one gap, it may be ensured that the spaced relation of the at least a part or portion of the plurality of turns of the second winding wound around the at least a portion of the magnetic element to the at least a part or portion of the plurality of turns of the first winding wound around the at least a portion of the magnetic element is maintained, and hence ensured that the at least one gap is maintained. The spacer may for example be solid, or semi-solid, and may for example be made of plastic or another or other types of electrically insulating material.

According to a second aspect, there is provided a system comprising an arrangement according to the first aspect. The system may comprise a vessel which may have an internal cavity. The at least a part or portion of the assembly that is arranged so as to be embedded in the thermally conductive material (while at the same time permitting a flow of air in the at least one gap) may be inserted into the internal cavity, wherein a space between an inner surface of the internal cavity and the at least a part or portion of the assembly that is inserted into the internal cavity may be at least in part filled with the thermally conductive material. Thereby, least a part or portion of the assembly may become embedded in the thermally conductive material. The vessel may possibly be made of thermally conductive material, and/or comprise cooling element(s), such as, for example, internal conduit(s) having a flow of cooling medium therein.

The system may comprise a heat transferring device. At least one surface of the vessel may be arranged to be connected to a surface of the heat transferring device for transferring heat from the vessel to the heat transferring device. The heat transferred from the vessel may be heat that has been generated by the arrangement when in use (e.g., when current is flowing in the first and second windings) and that has been transferred to the vessel by way of the thermally conductive material in which the at least a part or portion of the assembly of the arrangement is embedded. The heat transferring device may for example comprise a heatsink and/or a heat spreader, and/or a so called cold plate. The at least one surface of the vessel may be arranged to be at least thermally connected to the surface of the heat transferring device. Possibly, the at least one surface of the vessel may be arranged to mechanically connected to the surface of the heat transferring device. The at least one surface of the vessel may be arranged to be connected to the surface of the heat transferring device via a thermal interface material, such as, for example, thermal grease or thermal adhesive or the like.

According to a third aspect, there is provided a transformer comprising at least one arrangement according to the first aspect. As mentioned in the foregoing, the magnetic element may for example comprise at least one magnetic core for the transformer. The assembly of the arrangement may be referred to as a transformer assembly, and/or the arrangement may be referred to as a transformer arrangement.

In alternative, or in addition, at least one arrangement according to the first aspect could be comprised in or be constituted by one or more coupled inductors. Thus, one or more coupled inductors may comprise at least one arrangement according to the first aspect.

According to a fourth aspect, there is provided a method for manufacturing an arrangement comprising a magnetic element and at least a first winding and a second winding. Each of the first winding and the second winding is wound in a plurality of turns around at least a portion of the magnetic element so that the first winding becomes arranged in relation to the second winding, or vice versa, such that the plurality of turns of the second winding are arranged around the plurality of turns of the first winding, and such that at least a part or portion of the plurality of turns of the second winding wound around the at least a portion of the magnetic element becomes arranged in spaced relation to at least a part or portion of the plurality of turns of the first winding wound around the at least a portion of the magnetic element, thereby defining at least one gap between the at least a part or portion of the plurality of turns of the second winding and the at least a part or portion of the plurality of turns of the first winding. At least the magnetic element and the first winding and the second winding define an assembly of the arrangement. A part or portion of the assembly is embedded in a thermally conductive material such that at least a part or portion of the magnetic element, the first winding, and the second winding, respectively, is embedded in the thermally conductive material, and such that at the same time a flow of air (and/or another or other types of gas or fluid in the surroundings of the arrangement) in the at least one gap is permitted.

At least one spacer may be arranged in the at least one gap for maintaining the spaced relation of the at least a part or portion of the plurality of turns of the second winding to the at least a part or portion of the plurality of turns of the first winding. The at least one spacer may be arranged in the at least one gap such that a flow of air (and/or another or other types of gas or fluid in the surroundings of the arrangement) in the at least one gap is permitted. The at least one spacer may for example be arranged in the at least one gap, or the at least one spacer may be configured, so that the at least one spacer does not block or obstruct the at least gap, at least not completely.

The arranging of the at least one spacer in the at least one gap may comprise removably arranging the at least one spacer in the at least one gap (i.e., arranging the at least one spacer in the at least one gap so that it subsequently may be (relatively easily) removed).

The at least a part or portion of the plurality of turns of the second winding wound around the at least a portion of the magnetic element and the at least a part or portion of the plurality of turns of the first winding wound around the at least a portion of the magnetic element may be fixated, so as to fixate the spaced relation of the at least a part or portion of the plurality of turns of the second winding wound around the at least a portion of the magnetic element to the at least a part or portion of the plurality of turns of the first winding wound around the at least a portion of the magnetic element. The at least one spacer may (e.g., after the above-mentioned fixation) be removed from the at least one gap. Removing the at least one spacer from the at least one gap may facilitate flow of air in the at least one gap, and it may for example facilitate or allow for an increased flow of air in the at least one gap, thereby possibly increasing the efficiency in cooling of at least a portion of the plurality of turns of the second winding and/or the plurality of turns of the first winding, and possibly a portion of the magnetic element, by means of convection as air flows in the at least one gap.

The fixating of the at least a part or portion of the plurality of turns of the second winding wound around the at least a portion of the magnetic element and the at least a part or portion of the plurality of turns of the first winding wound around the at least a portion of the magnetic element so as to fixate the spaced relation of the at least a part or portion of the plurality of turns of the second winding wound around the at least a portion of the magnetic element to the at least a part or portion of the plurality of turns of the first winding wound around the at least a portion of the magnetic element, may for example comprise coating the at least a part or portion of the plurality of turns of the first winding wound around the at least a portion of the magnetic element and the at least a part or portion of the plurality of turns of the second winding wound around the at least a portion of the magnetic element with resin, and hardening the resin, e.g., by means of heating the resin. The resin may for example comprise one or more of thermosetting resin, epoxy resin, or urethane resin.

In alternative, or in addition, the fixating of the at least a part or portion of the plurality of turns of the second winding wound around the at least a portion of the magnetic element and the at least a part or portion of the plurality of turns of the first winding wound around the at least a portion of the magnetic element so as to fixate the spaced relation of the at least a part or portion of the plurality of turns of the second winding wound around the at least a portion of the magnetic element to the at least a part or portion of the plurality of turns of the first winding wound around the at least a portion of the magnetic element, may for example comprise curing the at least a part or portion of the plurality of turns of the first winding wound around the at least a portion of the magnetic element and the at least a part or portion of the plurality of turns of the second winding wound around the at least a portion of the magnetic element, making the cured at least a part or portion of the plurality of turns of the first winding wound around the at least a portion of the magnetic element and the at least a part or portion of the plurality of turns of the second winding wound around the at least a portion of the magnetic element rigid. The curing may for example comprise thermal and/or UV curing.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

FIG. 1 is a schematic perspective view of a system according to an embodiment of the present invention.

FIG. 2 is a cross sectional view of the system illustrated in FIG. 1.

FIG. 3 is a schematic flowchart of a method according to an embodiment of the present invention.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments are provided by way of example so that this disclosure will convey the scope of the present invention to those skilled in the art.

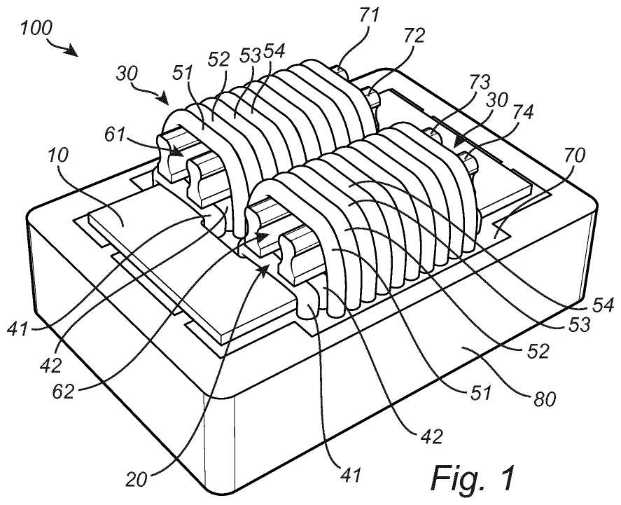

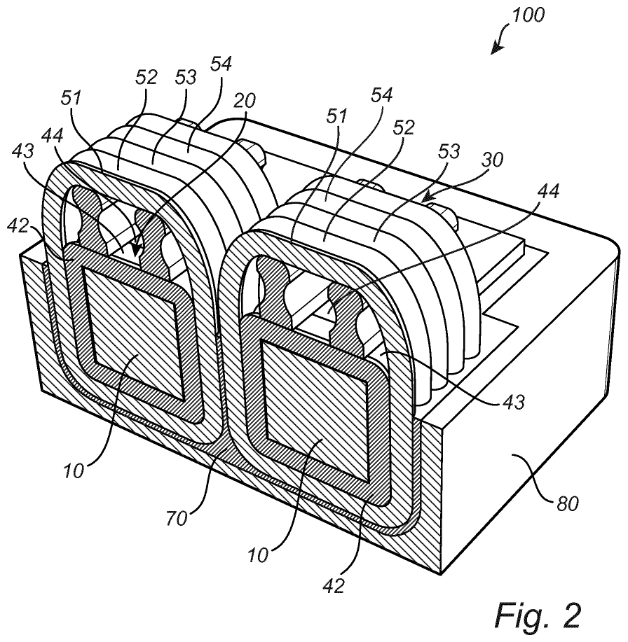

FIG. 1 is a schematic perspective view of a system 100 according to an embodiment of the present invention. FIG. 2 is a cross sectional view of the system 100 illustrated in FIG. 1. The system 100 comprises an arrangement 10, 20, 30 comprising a magnetic element 10, which in accordance with the embodiment of the present invention illustrated in FIGS. 1 and 2 comprises a magnetic core, and a first winding 20 and a second winding 30. In accordance with the embodiment of the present invention illustrated in FIGS. 1 and 2, the arrangement 10, 20, 30 is employed in a transformer. It is however to be understood that the arrangement 10, 20, 30 could be employed in other applications. In the following, the magnetic element 10 will be referred to as a magnetic core, for use in a transformer, but it is understood that the magnetic element 10 may not necessarily comprise a magnetic core for use in a transformer, but could, in alternative or in addition, comprise another or other types of magnetic elements.

In accordance with the embodiment of the present invention illustrated in FIGS. 1 and 2, the magnetic core 10 has a form in accordance with two connected U cores with sharp corners, and with the magnetic core 10 being monolithic. It is however to be understood that the form of the magnetic core 10 illustrated in FIGS. 1 and 2 is according to an example, and that other forms of the magnetic core 10 are possible. For example, the magnetic core 10 could comprise an E core, or a U core. The magnetic core 10 may in principle comprise any magnetic material, for example one or more ferrite ceramics. The magnetic core 10 may hence for example comprise a ‘ferrite core’. Also, even though the magnetic core 10 illustrated in FIGS. 1 and 2 has a square cross section, this is not required. It is to be understood that the magnetic core 10 may have any appropriate cross section.

The first winding 20 comprises a plurality of turns 41, 42, 43, 44 . . . (only some of the turns of the first winding 20 are indicated by reference numerals in FIGS. 1 and 2). The second winding 30 comprises a plurality of turns 51, 52, 53, 54 . . . (only some of the turns of the second winding 30 are indicated by reference numerals in FIGS. 1 and 2). It is to be understood that the number of turns of the first winding 20 and of the second winding 30, respectively, illustrated in FIGS. 1 and 2 is according to examples, and that the number of turns of the first winding 20 and of the second winding 30, respectively, may be larger or smaller than the number of turns of the first winding 20 and of the second winding 30, respectively, illustrated in FIGS. 1 and 2. It is to be noted that the reference numerals 41, 42, 43, 44 and the reference numerals 51, 52, 53, 54 in FIG. 1 indicate different turns of the first winding 20 and of the second winding 30, respectively, as compared with the reference numerals 41, 42, 43, 44 and the reference numerals 51, 52, 53, 54 in FIG. 2.

The plurality of turns 41, 42, 43, 44 of the first winding 30, and the plurality of turns 51, 52, 53, 54 of the second winding 30, respectively, are wound around two portions of the magnetic core 10. In accordance with the embodiment of the present invention illustrated in FIGS. 1 and 2, each of the first winding 20 and the second winding 30 is wound in a plurality of turns 41, 42, 43, 44 and 51, 52, 53, 54, respectively, around two portions of the magnetic core 10 so that the first winding 20 is arranged in relation to the second winding 30, or vice versa, such that the plurality of turns 51, 52, 53, 54 of the second winding 30 are arranged around the plurality of turns 41, 42, 43, 44 of the first winding 20. As illustrated in FIGS. 1 and 2, the plurality of turns 41, 42, 43, 44 of the first winding 20 and the plurality of turns 51, 52, 53, 54 of the second winding 30 form different layers running or extending in parallel along a longitudinal axis of the respective portions of core 10, with the layers formed by the plurality of turns 51, 52, 53, 54 of the second winding 30 being arranged over the layers formed by the plurality of turns 41, 42, 43, 44 of the first winding 20 in a direction away from the magnetic core 10.

On each of the two portions of the magnetic core 10, a part or portion of the plurality of turns 51, 52, 53, 54 of the second winding 30 wound around the portion of the magnetic core 10 is arranged in spaced relation to (i.e. at a distance from) a part or portion of the plurality of turns 41, 42, 43, 44 of the first winding 20 wound around the portion of the magnetic core 10, thereby defining two respective gaps 61, 62 between the respective part or portion of the plurality of turns 51, 52, 53, 54 of the second winding 30 and the respective part or portion of the plurality of turns 41, 42, 43, 44 of the first winding 20. In accordance with the embodiment of the present invention illustrated in FIGS. 1 and 2, the gaps 61, 62 are arranged between the layers formed by the plurality of turns 51, 52, 53, 54 of the second winding 30 and the layers formed by the plurality of turns 41, 42, 43, 44 of the first winding 20.

The magnetic core 10 and the first winding 20 and the second winding 30 define an assembly of the arrangement 10, 20, 30. As illustrated in FIGS. 1 and 2, a part or portion of the assembly is arranged so as to be embedded in a thermally conductive material 70 such that at the same time a flow of air in the gaps 61, 62 is permitted.

The system 100 may for example be arranged in surrounding, ambient air, such that a flow of (ambient) air in the gaps 61, 62 is permitted. However, if the system 100 would be arranged in another or other types of gas or fluid, surrounding the system 100, a flow of such other type(s) of gas or fluid in the gaps 61, 62 may be permitted.

As illustrated in FIGS. 1 and 2, the parts or portions of the plurality of turns 41, 42, 43, 44 and 51, 52, 53, 54 of the first winding 20 and the second winding 30, respectively, which are delimiting, or bordering, spaces formed by the respective ones of the gaps 61, 62 are not embedded in the thermally conductive material 70. Thereby, a flow of air in the gaps 61, 62 is permitted, and it may further be facilitated or allowed for ensuring that a relatively high flow of air in the gaps 61, 62 may take place, thereby providing for a relatively high efficiency in cooling of the plurality of turns 51, 52, 53, 54 of the second winding 30 and/or the plurality of turns 41, 42, 43, 44 of the first winding 20, and possibly a portion of the magnetic core 10, by means of convection as air flows in the gaps 61, 62. This may be further facilitated by each of the gaps 61, 62 extending between two open ends thereof, as illustrated in FIGS. 1 and 2, such that each of the two ends opens into the surroundings of the arrangement 10, 20, 30, and such that air may flow from one end to the other end.

In accordance with the embodiment of the present invention illustrated in FIGS. 1 and 2, about half of the assembly defined by the magnetic core 10 and the first winding 20 and the second winding 30 is embedded in the thermally conductive material 70. It is however to be understood that less or more of the assembly than what is illustrated in FIGS. 1 and 2 may be embedded in the thermally conductive material 70. For example, less than a fourth, or a fifth, or a sixth of the assembly may be embedded in the thermally conductive material 70. It is to be understood that the ‘height’ of the thermally conductive material 70 (with respect to a direction upward in FIG. 2) may be lower or higher than illustrated in FIG. 2. For example, while the ‘height’ of the thermally conductive material 70 is lower than an upper (with respect to a direction upward in FIG. 2) side of the core 10 in FIG. 2, the height’ of the thermally conductive material 70 could be higher than the upper side of the core 10. It is also to be understood that there may be (possibly relatively small) gaps between adjacent turns of the plurality of turns 51, 52, 53, 54 of the second winding 30 and/or between adjacent turns of the plurality of turns 41, 42, 43, 44 of the first winding 20, such that the thermally conductive material 70 may come into contact with the thermally conductive material 70.

In accordance with the embodiment of the present invention illustrated in FIGS. 1 and 2, spacers 71, 72 are arranged within the gap 61 and spacers 73, 74 are arranged within the gap 62. The spacers 71, 72 and 73, 74 are arranged for maintaining the spaced relation between the parts or portions of the plurality of turns 51, 52, 53, 54 of the second winding 30 wound around the portion of the magnetic core 10 and the parts or portions of the plurality of turns 41, 42, 43, 44 of the first winding 20 wound around the portion of the magnetic core 10 which define the gaps 61 and 62, respectively. As illustrated in FIGS. 1 and 2, the spacers 71, 72, 73, 74 are arranged within the gaps 61 and 62 so as to still permit a flow of air in the gaps 61, 62. There may be less or more than two spacers arranged within the gap 61 or the gap 62. Further, it is to be understood that the spacers 71, 72, 73, 74 are optional and may be omitted. For example, the spacers 71, 72, 73, 74 may be removably arranged in the gaps 61, 62 so that they subsequently may be (relatively easily) removed. The parts or portions of the plurality of turns 51, 52, 53, 54 of the second winding 30 wound around the portion of the magnetic core 10 and the parts or portions of the plurality of turns 41, 42, 43, 44 of the first winding 20 wound around the portion of the magnetic core 10 which define the gaps 61 and 62, respectively, may be fixated for example employing a resin or by curing, such as described in the foregoing. After the fixation, the spacers 71, 72, 73, 74 may be removed from the gaps 61, 62.

The system 100 comprises a vessel 80 which has an internal cavity. The part or portion of the assembly, which is defined by magnetic core 10 and the first winding 20 and the second winding 30, and which is embedded in the thermally conductive material 70, has been inserted into the internal cavity of the vessel 80. As best illustrated in FIG. 2, a space between an inner surface of the internal cavity and the part or portion of the assembly inserted into the internal cavity has been filled with the thermally conductive material 70 such that the part or portion of the assembly is embedded in the thermally conductive material 70.

The vessel 80 may be made of a thermally conductive material. By means of the thermally conductive material 70 in which the part or portion of the assembly, defined by magnetic core 10 and the first winding 20 and the second winding 30, is embedded, any heat generated by the magnetic core 10, the first winding 20 and/or the second winding 30 when in use (e.g., when current is flowing in the first and second windings 20, 30) may be transferred to the vessel 80. Possibly, a surface of the vessel 80 may be connected to a surface of a heat transferring device (not shown in FIGS. 1 and 2) for transferring heat from the vessel to the heat transferring device. For example, a bottom surface of the vessel 80 may be connected to a surface of a heat transferring device. The heat transferring device may for example comprise a heatsink and/or a heat spreader, and/or a so called cold plate. Possibly, a surface of the vessel 80 may be connected to a surface of a heat transferring device via a thermal interface material, such as, for example, thermal grease or thermal adhesive or the like.

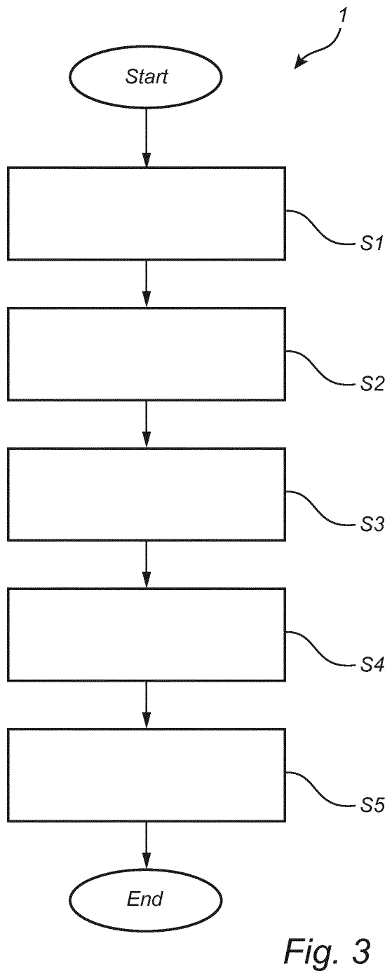

FIG. 3 is a schematic flowchart of a method 1 according to an embodiment of the present invention. The method 1 is for manufacturing an arrangement comprising a magnetic element and at least a first winding and a second winding. At S1, each of the first winding and the second winding is wound in a plurality of turns around at least a portion of the magnetic element so that the first winding becomes arranged in relation to the second winding, or vice versa, such that the plurality of turns of the second winding are arranged around the plurality of turns of the first winding, and such that at least a part or portion of the plurality of turns of the second winding wound around the at least a portion of the magnetic element becomes arranged in spaced relation to at least a part or portion of the plurality of turns of the first winding wound around the at least a portion of the magnetic element, thereby defining at least one gap between the at least a part or portion of the plurality of turns of the second winding and the at least a part or portion of the plurality of turns of the first winding. At least the magnetic element and the first winding and the second winding define an assembly of the arrangement. At S2, a part or portion of the assembly is embedded in a thermally conductive material such that at least a part or portion of the magnetic element, the first winding, and the second winding, respectively, is embedded in the thermally conductive material, and such that at the same time a flow of air (and/or another or other types of gas or fluid in the surroundings of the arrangement) in the at least one gap is permitted. The method 1 may then end.

Possibly, at S3, at least one spacer may be arranged in the at least one gap for maintaining the spaced relation of the at least a part or portion of the plurality of turns of the second winding to the at least a part or portion of the plurality of turns of the first winding. The at least one spacer may be arranged in the at least one gap such that a flow of air (and/or another or other types of gas or fluid in the surroundings of the arrangement) in the at least one gap is permitted. The at least one spacer may for example be arranged in the at least one gap, or the at least one spacer may be configured, so that the at least one spacer does not block or obstruct the at least gap, at least not completely.

The arranging of the at least one spacer in the at least one gap may comprise removably arranging the at least one spacer in the at least one gap (i.e., arranging the at least one spacer in the at least one gap so that it subsequently may be (relatively easily) removed).

Possibly, at S4, the at least a part or portion of the plurality of turns of the second winding wound around the at least a portion of the magnetic element and the at least a part or portion of the plurality of turns of the first winding wound around the at least a portion of the magnetic element may be fixated, so as to fixate the spaced relation of the at least a part or portion of the plurality of turns of the second winding wound around the at least a portion of the magnetic element to the at least a part or portion of the plurality of turns of the first winding wound around the at least a portion of the magnetic element. At S5, the at least one spacer may (e.g., after the above-mentioned fixation) be removed from the at least one gap.

As also indicated in the foregoing, each of the steps S3, S4 and S5 is optional.

Various aspects of the present invention may be appreciated from the following enumerated example embodiments (EEEs):

EEE 1. An arrangement (10, 20, 30) comprising:

a magnetic element (10); and

at least a first winding (10) and a second winding (20), wherein each of the first winding and the second winding is wound in a plurality of turns (41, 42, 43, 44, 51, 52, 53, 54) around at least a portion of the magnetic element, and wherein at least a part or portion of the plurality of turns of the second winding wound around the at least a portion of the magnetic element is arranged in spaced relation to at least a part or portion of the plurality of turns of the first winding wound around the at least a portion of the magnetic element, thereby defining at least one gap (61, 62) between the at least a part or portion of the plurality of turns of the second winding and the at least a part or portion of the plurality of turns of the first winding;

wherein at least the magnetic element and the first winding and the second winding define an assembly of the arrangement, and wherein at least a part or portion of the assembly is arranged so as to be embedded in a thermally conductive material (70) and such that at the same time a flow of air in the at least one gap is permitted.

EEE 2. An arrangement according to EEE 1, wherein each of the first winding and the second winding is wound in a plurality of turns around at least a portion of the magnetic element so that the first winding is arranged in relation to the second winding, or vice versa, such that the plurality of turns of the second winding are arranged around the plurality of turns of the first winding.
EEE 3. An arrangement according to EEE 1 or 2, wherein the part or portion of the plurality of turns of the first winding and the part or portion of the plurality of turns of the second winding defining the at least one gap are not embedded in the thermally conductive material.
EEE 4. An arrangement according to any one of EEEs 1-3, wherein the at least one gap extends between at least two ends thereof, wherein the at least a part or portion of the assembly is arranged so as to be embedded in a thermally conductive material in such a way that at least two of the ends of the at least one gap opens into the surroundings of the arrangement, and such that air may flow from one of the ends to another end.
EEE 5. An arrangement according to any one of EEEs 1-4, wherein each of the first winding and the second winding is wound in a plurality of turns around at least a portion of the magnetic element such that the at least one gap between the at least a part or portion of the plurality of turns of the second winding and the at least a part or portion of the plurality of turns of the first winding is extending along or parallel with a longitudinal axis of the at least a portion of the magnetic element.
EEE 6. An arrangement according to any one of EEEs 1-5, wherein the magnetic element comprises at least one magnetic core (10), wherein the at least one magnetic core has at least one leg, and wherein the at least a portion of the magnetic element around which the first winding and the second winding are wound is located in a single leg of the at least one magnetic core.
EEE 7. An arrangement according to any one of EEEs 1-5, wherein the magnetic element comprises at least one magnetic core (10), wherein the at least one magnetic core has a plurality of legs, and wherein the at least a portion of the magnetic element around which the first winding and the second winding are wound is located in several legs of the at least one magnetic core.
EEE 8. An arrangement according to any one of EEEs 1-7, wherein less than half of the assembly is embedded in the thermally conductive material.
EEE 9. A system (100) comprising:

an arrangement (10, 20, 30) according to any one of EEEs 1-8; and

a vessel (80) having an internal cavity, wherein the at least a part or portion of the assembly arranged so as to be embedded in the thermally conductive material is inserted into the internal cavity, wherein a space between an inner surface of the internal cavity and the at least a part or portion of the assembly inserted into the internal cavity is at least in part filled with the thermally conductive material.

EEE 10. A transformer comprising at least one arrangement (10, 20, 30) according to any one of EEEs 1-8.
EEE 11. A method (1) for manufacturing an arrangement comprising a magnetic element and at least a first winding and a second winding, the method comprising:

winding (S1) each of the first winding and the second winding in a plurality of turns around at least a portion of the magnetic element such that at least a part or portion of the plurality of turns of the second winding wound around the at least a portion of the magnetic element becomes arranged in spaced relation to at least a part or portion of the plurality of turns of the first winding wound around the at least a portion of the magnetic element, thereby defining at least one gap between the at least a part or portion of the plurality of turns of the second winding and the at least a part or portion of the plurality of turns of the first winding;

wherein at least the magnetic element and the first winding and the second winding define an assembly of the arrangement, and wherein the method further comprises:

embedding (S2) at least a part or portion of the assembly in a thermally conductive material such that at the same time a flow of air in the at least one gap is permitted.

EEE 12. A method according to EEE 11, further comprising:

arranging (S3) at least one spacer in the at least one gap for maintaining the spaced relation of the at least a part or portion of the plurality of turns of the second winding to the at least a part or portion of the plurality of turns of the first winding.

EEE 13. A method according to EEE 12, wherein the at least one spacer is arranged in the at least one gap such that a flow of air in the at least one gap is permitted.
EEE 14. A method according to EEE 12 or 13, wherein the arranging of the at least one spacer in the at least one gap comprises removably arranging the at least one spacer in the at least one gap.
EEE 15. A method according to EEE 14, further comprising:

fixating (S4) the at least a part or portion of the plurality of turns of the second winding wound around the at least a portion of the magnetic element and the at least a part or portion of the plurality of turns of the first winding wound around the at least a portion of the magnetic element so as to fixate the spaced relation of the at least a part or portion of the plurality of turns of the second winding wound around the at least a portion of the magnetic element to the at least a part or portion of the plurality of turns of the first winding wound around the at least a portion of the magnetic element; and

removing (S5) the at least one spacer from the at least one gap.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1.-14. (canceled)

15. An arrangement comprising:
a magnetic element; and
a first winding and a second winding, wherein each of the first winding and the second winding is wound in a plurality of turns around a portion of the magnetic element such that the first winding is arranged in relation to the second winding such that the plurality of turns of the second winding are arranged around the plurality of turns of the first winding,
wherein at least a portion of the plurality of turns of the second winding is arranged in a spaced relation to at least a portion of the plurality of turns of the first winding, thereby defining a gap between said portion of the second winding and said portion of the first winding,
wherein the magnetic element, the first winding, and the second winding define an assembly of the arrangement, and wherein a portion of the assembly is arranged so as to be embedded in a thermally conductive material such that a portion of each of the magnetic element, the first winding, and the second winding, are embedded in the thermally conductive material while allowing for a flow of air to pass through the gap.

16. The arrangement of claim 15, wherein the portions of the plurality of turns of the first winding and the second winding that define the gap are not embedded in the thermally conductive material.

17. The arrangement of claim 15, wherein the gap extends between two ends of the assembly such that the ends of the gap open into the surroundings of the arrangement, and such that air may flow from one of the ends to the other end.

18. The arrangement of claim 15, wherein the gap extends parallel to a longitudinal axis of the magnetic element.

19. The arrangement of claim 15, wherein the magnetic element comprises a magnetic core, wherein the magnetic core comprises a leg, and wherein the first winding and the second winding are wound around the leg.

20. The arrangement of claim 15, wherein the magnetic element comprises a magnetic core, wherein the magnetic core has a plurality of legs, and wherein the first winding and the second winding are wound around each of the plurality of legs.

21. The arrangement of claim 15, wherein less than half of the assembly is embedded in the thermally conductive material.

22. The arrangement of claim 15, wherein the arrangement is partially disposed in a vessel having an internal cavity adapted to receive the arrangement, wherein the portion of the assembly embedded in the thermally conductive material is inserted into the internal cavity, wherein a space between an inner surface of the internal cavity and the assembly is at least in part filled with the thermally conductive material.

23. The arrangement of claim 15, wherein the arrangement is a portion of a transformer.

24. A method for manufacturing an arrangement comprising a magnetic element, a first winding, and a second winding, the method comprising:
winding each of the first winding and the second winding in a plurality of turns around a portion of the magnetic element such that the plurality of turns of the second winding are arranged around and spaced apart from the plurality of turns of the first winding to define a gap, wherein the magnetic element, the first winding, and the second winding define an assembly of the arrangement; and
embedding a portion of the assembly in a thermally conductive material while allowing for a flow of air to pass through the gap.

25. The method of claim 24, further comprising arranging a spacer in the gap for maintaining the space between the second winding and the first winding.

26. The method of claim 25, wherein the spacer is arranged in the gap such that the flow of air is not blocked.

27. The method of claim 25, wherein the spacer is removeable.

28. The method of claim 25, further comprising:
fixing the first winding and the second winding; and
removing the spacer from the gap.

29. An arrangement comprising:
a magnetic element;
a first winding wound in a plurality of turns around a portion of the magnetic element;
a second winding, wound in a plurality of turns around the first winding and distally spaced from the first winding to define a gap between the first winding and the second winding; and
a thermally conductive material for embedding a portion of each of the magnetic element, the first winding, and the second winding, while allowing a flow of air to pass through the gap.

30. The arrangement of claim 29, wherein the gap extends parallel to a longitudinal axis of the magnetic element.

31. The arrangement of claim 29, wherein the magnetic element comprises a magnetic core.

32. (canceled)

32. (canceled)

33. The arrangement of claim 29, wherein the portion of the magnetic element, the first winding, and the second winding that are embedded in the thermally conductive material is partially disposed in a vessel.

34. The arrangement of claim 29, wherein the arrangement is a portion of a transformer.

35. The arrangement of claim 31, wherein the magnetic core is U-shaped.

36. The arrangement of claim 31, wherein the magnetic core is E-shaped.
